(19) United States
(12) Patent Application Publication
(10) Pub. No.: US 2021/0320977 A1
(43) Pub. Date: Oct. 14, 2021

(54) METHOD AND APPARATUS FOR IMPLEMENTING DATA CONSISTENCY, SERVER, AND TERMINAL

(71) Applicant: Huawei Technologies Co., Ltd., Shenzhen (CN)

(72) Inventors: Wei HUANG, Chengdu (CN); Peng XU, Xi'an (CN)

(21) Appl. No.: 17/356,030

(22) Filed: Jun. 23, 2021

Related U.S. Application Data
(63) Continuation of application No. PCT/CN2019/106074, filed on Sep. 17, 2019.

(30) Foreign Application Priority Data
Dec. 24, 2018 (CN) 201811585072.1

(51) Int. Cl. H04L 29/08; G06F 16/23

(52) U.S. Cl. CPC H04L 67/1097; G06F 16/2365

(57) ABSTRACT

In this application, a client generates an operation for data, and records the operation as a log entry. The client sends the log entry to nodes comprising a leader and a plurality of followers. The client receives a plurality of response messages in a preset time period, where the response messages indicate that the operation is successfully performed. Different response messages are from different nodes. When a total quantity of the plurality of response messages received by the client in the preset time period is greater than half of a quantity of nodes, the client determines that the operation is successfully performed.

### CROSS-REFERENCE TO RELATED APPLICATIONS

This application is a continuation of International Patent Application No. PCT/CN2019/106074, filed on Sep. 17, 2019, which claims priority to Chinese Patent Application No. 201811585072.1, filed on Dec. 24, 2018. The disclosures of the aforementioned applications are hereby incorporated by reference in their entireties.

### TECHNICAL FIELD

This application relates to the computer field, and in particular, to a method and an apparatus for implementing data consistency, a terminal, a server, and a computer program product.

### BACKGROUND

In a distributed storage system, a plurality of copies are often used to improve availability of the distributed storage system. When a storage node in which a copy is located is offline, a node in which another copy is located substitutes for the storage node and provides copy data. However, a prerequisite is that data of the plurality of copies is consistent.

In the distributed storage system, common distributed consistency protocols include the Raft protocol, the Paxos protocol, the two-phase commit protocol (2PC), and the three-phase commit protocol (3PC). The Raft protocol is commonly considered as a protocol that is easiest to understand, and therefore is widely used in the distributed storage system (for example, a distributed database).

In the Raft protocol, a log is used to record an operation (such as a read operation or a write operation) of a client for data. Log replication in the Raft protocol is as follows: Step 1: A leader receives a log entry from a client, where the log entry carries an operation (including data on which the operation is targeted) of the client. Step 2: The leader copies the log entry to another follower. Step 3: More than half of followers send, to the leader, information indicating that the operation carried in the log entry has been performed successfully. Step 4: The leader notifies the client that the operation has been completed.

### SUMMARY

In view of this, this application provides a method and an apparatus for implementing data consistency, a server, a terminal, and a computer program product, to improve efficiency of implementing an operation (read operation/write operation) according to the Raft protocol.

According to a first aspect, this application provides a method for implementing data consistency. In this method, a client defined in the Raft protocol generates an operation for data and records the operation as a log entry. The client sends the log entry to a leader defined in the Raft protocol and a plurality of followers defined in the Raft protocol. The leader and all the followers separately receive the log entry, separately perform the operation recorded in the log entry, and separately send response messages indicating that the operation is successfully performed to the client after successfully performing the operation. The client receives a plurality of response messages in a preset time period, where the response messages indicate that the operation is successfully performed. Different response messages in the plurality of response messages are from different nodes. For example, all of the plurality of response messages are from the plurality of followers. For another example, one of the plurality of response messages is from the leader, and the other response messages are from the plurality of followers. When a total quantity of the plurality of response messages received by the client in the preset time period is greater than half of a quantity of nodes, the client determines that the operation is successfully performed, where the quantity of nodes is a sum of a quantity of the leader and a quantity of the plurality of followers.

Compared with the background, the method provided in this application omits actions such as an action that the leader is responsible for delivering the operation and determining whether the operation is performed. The client directly delivers the operation and determines whether the operation is successfully performed. This can improve completion efficiency of the operation.

In an embodiment of the first aspect, the leader sends a term ID of the leader to the client, and the client receives the term ID sent by the leader. In this way, the client may identify a current leader (namely, a latest leader) by using a largest term ID.

In an embodiment of the first aspect, the client adds the term ID of the current leader to the log entry. In this way, the current leader and all the followers identify the log entry generated in a term of the current leader, and then stop performing an operation in a log entry generated in a term of an old leader.

In an embodiment of the first aspect, the follower periodically detects a communication connection between the follower and the leader, and when the communication connection between the follower and the leader is disconnected, suspends execution of the operation recorded in the log entry that carries the term ID of the leader. This can prevent data inconsistency caused by performing the operation recorded in the log entry.

In an embodiment of the first aspect, the follower periodically detects the communication connection between the follower and the leader, and the follower becomes a candidate when the communication connection between the follower and the leader is disconnected. The candidate initiates election to another follower and the leader, and when the candidate is elected as a new leader, the new leader sends a new term ID of the new leader to the client.

In this way, the client may obtain the new term ID of the new leader, and add the new term ID to a log entry generated in a term of the new leader.

In an embodiment of the first aspect, when the client receives the new term ID sent by the new leader, and the new term ID is greater than an old term ID of an old leader, the client obtains a log entry that carries the old term ID and that is not completely executed. The client updates the old term ID in the obtained log entry to the new term ID. The client sends a log entry that carries the new term ID to the old leader, the new leader, and a follower other than the new leader in all the followers.

In this way, for a log entry (carrying the old term ID) generated in a term of the old leader, when the leader is updated, if the client determines that one or more log entries have not been successfully executed, the client updates the old term ID in the one or more determined log entries to the new term ID. Thus, the operation in the log entry that is not successfully executed in a term of the old leader may be continued in a term of the new leader, thereby ensuring continuity and correctness of data update.

According to a second aspect, this application provides an apparatus for implementing data consistency, and a functional module included in the apparatus is configured to implement steps performed by the client in the method provided in the first aspect or any possible design of the first aspect.

This application provides another apparatus for implementing data consistency, and a functional module included in the apparatus is configured to implement steps performed by a node (the leader, the follower, or the candidate) in the method provided in the first aspect or any possible design of the first aspect.

According to a third aspect, this application provides a terminal. The terminal includes a display, a processor, and a memory. The memory stores a computer instruction, and the processor executes the computer instruction stored in the memory, so that the terminal performs steps implemented by the client in the method provided in the first aspect or the possible designs of the first aspect.

This application provides a server. The server includes a processor and a memory. The memory stores a computer instruction, and the processor executes the computer instruction stored in the memory, so that the server performs steps implemented by a node (the leader, the follower, or the candidate) in the method provided in the first aspect or the possible designs of the first aspect.

According to a fourth aspect, this application provides a computer-readable storage medium. The computer-readable storage medium stores a computer instruction. When a processor of a terminal executes the computer instruction, the terminal performs steps implemented by the client in the method provided in the first aspect or the possible designs of the first aspect.

This application provides a computer-readable storage medium. The computer-readable storage medium stores a computer instruction. When a processor of a server executes the computer instruction, the server performs steps implemented by a node (the leader, the follower, or the candidate) in the method provided in the first aspect or the possible designs of the first aspect.

This application provides a computer program product. The computer program product includes a computer instruction, and the computer instruction is stored in the computer-readable storage medium. The processor of the terminal may read the computer instruction from the computer-readable storage medium, and the processor executes the computer instruction, so that the terminal performs the steps implemented by the client in the method provided in the first aspect or the possible designs of the first aspect.

This application provides a computer program product. The computer program product includes a computer instruction, and the computer instruction is stored in the computer-readable storage medium. The processor of the server may read the computer instruction from the computer-readable storage medium, and the processor executes the computer instruction, so that the server performs the steps implemented by the node (the leader, the follower, or the candidate) in the method provided in the first aspect or the possible designs of the first aspect.

### BRIEF DESCRIPTION OF DRAWINGS

FIG. 1 is a schematic diagram of an application scenario to which this application is applicable;

FIG. 2 is a schematic flowchart of a method for implementing data consistency according to this application;

FIG. 3 is a schematic flowchart of a method for implementing data consistency according to this application;

FIG. 4 is a schematic diagram of a logical structure of an apparatus 400 for implementing data consistency according to this application;

FIG. 5 is a schematic diagram of a logical structure of an apparatus 500 for implementing data consistency according to this application;

FIG. 6 is a schematic structural diagram of a terminal 10 according to this application; and

FIG. 7 is a schematic structural diagram of a server 700 according to this application.

### DESCRIPTION OF EMBODIMENTS

The following describes technical solutions in this application with reference to accompanying drawings in this application.

The Raft protocol is a consistency algorithm protocol and can replace the Paxos protocol. A node defined in Raft may be any one of the following: a leader, a follower, and a candidate.

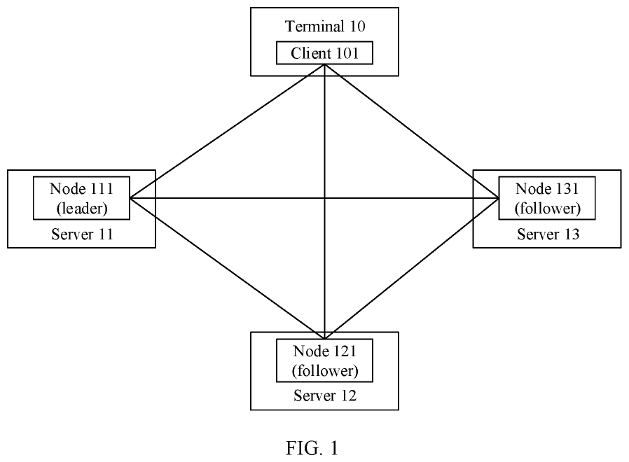

Referring to FIG. 1, a client 101 defined in the Raft protocol is deployed on a terminal 10. A node 111, a node 121, and a node 131 that are defined in the Raft protocol are respectively deployed on a server 11, a server 12, and a server 13. When the node 111 is elected as a current leader (leader), the node 121 and the node 131 are current followers (follower). FIG. 1 is merely a schematic diagram. The Raft protocol further supports a case in which clients are separately deployed on a plurality of terminals, and a case in which one or more nodes are deployed on each of a plurality of servers. Working principles of the clients separately deployed on the plurality of terminals are similar.

The client 101 communicates with each of the leader 111, the follower 121, and the follower 131. In this way, the client 101 may directly send a to-be-processed log entry to each of the leader 111, the follower 121, and the follower 131. The log entry records an operation and data on which the operation is targeted. For example, the log entry records a write operation of the client for new data. For another example, the log entry records a read operation of the client for old data.

It should be known that, if there is another follower other than the follower 121 and the follower 131, the client 101 may directly send a to-be-processed operation to the another follower.

Optionally, if applicable to a distributed storage system that supports the Raft protocol, the client 101 is a client in the distributed storage system, and the leader 111, the follower 121, and the follower 131 are storage nodes in the distributed storage system. For example, the client is a database application.

Optionally, if applicable to a distributed database that supports the Raft protocol, the client 101 is an interface provided by the distributed database for an application, and the leader 111, the follower 121, and the follower 131 are database nodes in the distributed database.

This application provides a method for implementing data consistency according to the Raft protocol. In this method, actions such as sending an operation by the leader 111 and determining whether the operation is successfully performed are omitted, so that load of the leader 111 is reduced in comparison with that in the background.

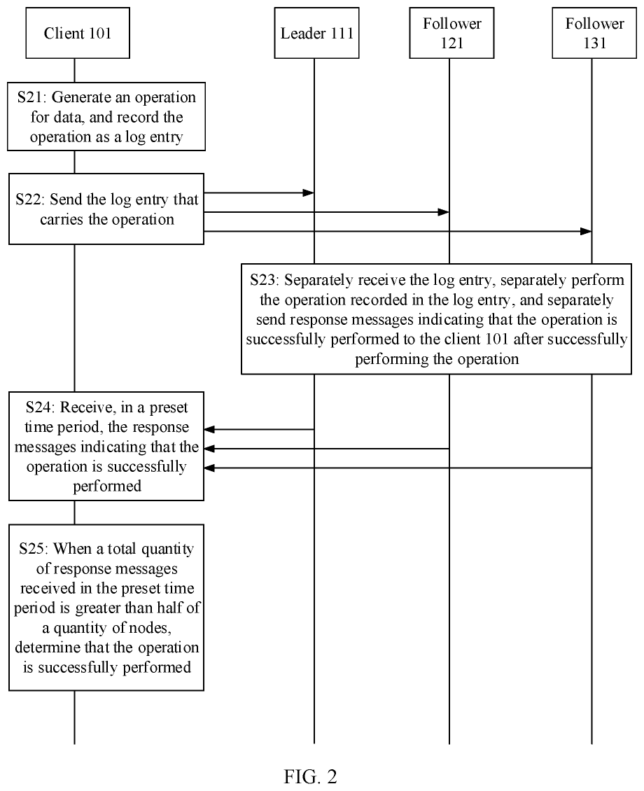

With reference to FIG. 1, FIG. 2 shows a basic procedure of the method. The procedure includes step S21 to step S25. It should be learned that there may be one or more followers. FIG. 1 and FIG. 2 show a scenario of two followers. An implementation principle of applying this method to a scenario of one or more followers is similar to that of applying this method to the scenario of the two followers shown in FIG. 2.

Step S21: The client 101 generates an operation for data, and records the operation as a log entry (log entry).

A user may operate the client 101 on the terminal 10 to generate the operation for the data. The operation may be a read operation for reading the data, or the operation may be a write operation for writing the data.

An application (for example, a text editing application) may trigger the client 101 on the terminal 10 to generate the operation for the data. The operation may be a read operation for reading the data, or the operation may be a write operation for writing the data.

The client 101 records the operation for the data as the log entry in a log. For example, one operation generated by the client 101 is recorded as one log entry in the log.

Optionally, when recording the operation for the data in the log entry, the client 101 may further record a current term ID (termid) in the log entry. The current term ID is a term ID of the leader 111, and the current term ID is a largest term ID.

Before recording the current term ID in the log entry, the client 101 stores the current term ID. The client 101 obtains the current term ID in the following manner:

When the node 111 is elected as a leader in a current term (namely, the latest leader), the leader 111 sends the current term ID to the client 101. Correspondingly, the client receives the term ID sent by the leader 111. It should be known that, in the Raft protocol, the current term ID is the largest term ID, that is, the term ID recorded by the leader 111 in the current term is greater than a term ID recorded by another node (for example, the follower 121 or the follower 131), and the current term ID is the latest term ID.

Step S22: The client 101 sends the log entry that carries the operation to the leader 111 and all followers (for example, the follower 121 and the follower 131).

Optionally, the client 101 may simultaneously send the log entry to the leader 111 and all the followers (for example, the follower 121 and the follower 131).

Optionally, the client 101 may successively send the log entry to the leader 111 and all the followers (for example, the follower 121 and the follower 131). It should be known that, a time interval of sending the log entry to the leader 111 and all the followers (for example, the follower 121 and the follower 131) should be limited to a specified time period, and the specified time period should be as short as possible. For example, the specified time period is several seconds.

Step S23: The leader 111 and all the followers (for example, the follower 121 and the follower 131) separately receive the log entry, separately perform the operation recorded in the log entry, and separately send response messages indicating that the operation is successfully performed to the client 101 after successfully performing the operation.

After receiving the log entry, the leader 111 and all the followers (for example, the follower 121 and the follower 131) separately perform the operation recorded in the log entry. For example, the leader 111 writes, based on a write operation recorded in the log entry, data carried in the write operation into a storage area (the storage area is allocated by the server 11) managed by the leader 111. For example, the follower 121 writes, based on the write operation recorded in the log entry, the data carried in the write operation into a storage area (the storage area is allocated by the server 12) managed by the follower 121.

After successfully performing the operation recorded in the log entry, the leader 111 sends a response message indicating that the operation is successfully performed to the client 101. Optionally, if the leader 111 fails to perform the operation recorded in the log entry, the leader 111 sends no response message indicating that the operation is successfully performed to the client 101, or sends a response message indicating that the operation fails to be performed to the client 101.

After successfully performing the operation recorded in the log entry, a follower (for example, the follower 121 or the follower 131) sends a response message indicating that the operation is successfully performed to the client 101. Optionally, if the follower fails to perform the operation recorded in the log entry, the follower sends no response message indicating that the operation is successfully performed to the client 101, or sends a response message indicating that the operation fails to be performed to the client 101.

Step S24: The client 101 receives, in a preset time period, a response message indicating that the operation is successfully performed.

In other words, the response message describes that the operation is successfully performed.

If the leader 111 successfully performs the operation, the client 101 receives the response message sent by the leader 111 for indicating that the operation is successfully performed. In a normal case, the client 101 receives, in the preset time period, the response message sent by the leader 111 for indicating that the operation is successfully performed.

If the follower successfully performs the operation, the client 101 receives the response message sent by the follower for indicating that the operation is successfully performed. For example, the follower 121 successfully performs the operation, and the client 101 receives a response message sent by the follower 121 for indicating that the operation is successfully performed. In addition, the follower 131 successfully performs the operation, and the client 101 receives a response message sent by the follower 131 for indicating that the operation is successfully performed. In a normal case, the client 101 receives, in the preset time period, the response message sent by the follower for indicating that the operation is successfully performed.

Step S25: When a total quantity of response messages received by the client 101 in the preset time period is greater than half of a quantity of nodes, determine that the operation is successfully performed.

Specifically, if the client 101 receives response messages (response messages indicating that the operation is successfully performed) from more than half of all nodes (the leader 111 and all the followers) in the preset time period, the client 101 considers that the operation is successfully performed. Optionally, if the client 101 does not receive response messages (response messages indicating that the operation is successfully performed) from more than half of all nodes (the leader 111 and all the followers) in the preset time period, the client 101 considers that the operation fails to be performed.

For example, in the scenario in FIG. 1 and FIG. 2, if the client 101 receives response messages (response messages indicating that the operation is successfully performed) from at least two of the three nodes (the leader 111, the follower 121, and the follower 131) in the preset time period, the client 101 considers that the operation is successfully performed. On the contrary, if the client 101 receives response messages (response messages indicating that the operation is successfully performed) from less than two of the three nodes (the leader 111, the follower 121, and the follower 131) in the preset time period, the client 101 considers that the operation fails to be performed.

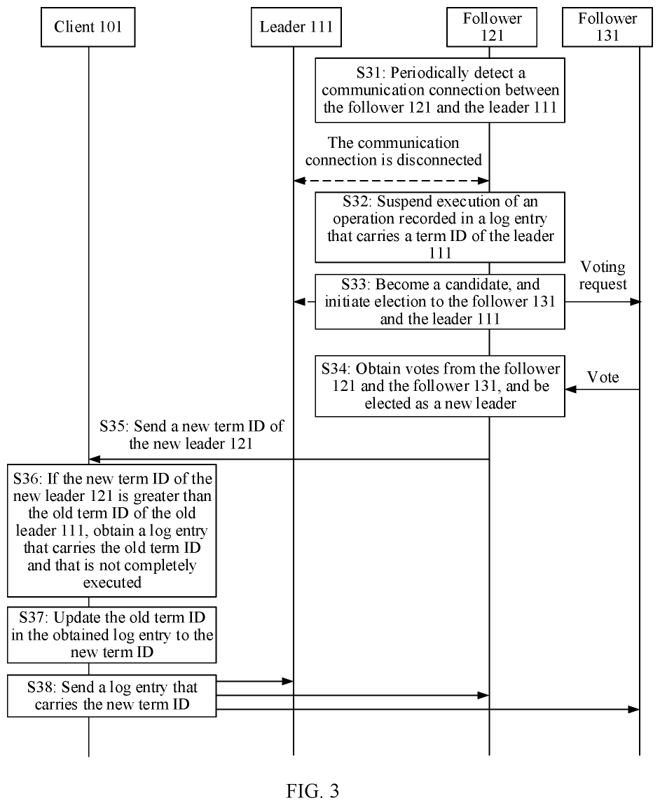

The procedure shown in FIG. 2 is a procedure of performing an operation in a normal case. On a basis that the operation is normally performed in FIG. 2, this application further shows a processing procedure in an abnormal case with reference to FIG. 1 and FIG. 3. The processing procedure shown in FIG. 3 includes step S31 to step S38. For ease of understanding, step S31 to step S35 in the processing procedure shown in FIG. 3 are described by using an example from a perspective of the follower 121. It should be learned that step S31 to step S35 are also applicable to another follower (for example, the follower 131). Implementation principles applicable to all followers are the same.

Step S31: The follower 121 periodically detects a communication connection between the follower 121 and the leader 111.

The follower 121 detects the communication connection between the follower 121 and the leader 111 every preset time period. The preset time period may be set manually, may be set according to historical experience, or may be set according to the Raft protocol.

Optionally, the follower 121 detects the communication connection between the follower 121 and the leader 111 by using a heartbeat mechanism. Specifically, the leader 111 periodically sends a heartbeat data packet to the follower 121. If the follower 121 does not receive the heartbeat data packet before expiration, the follower 121 determines that the communication connection between the follower 121 and the leader 111 is disconnected.

In addition, if the leader 111 is faulty, the follower 121 detects that the communication connection between the follower 121 and the leader 111 is disconnected.

Step S32: When the communication connection between the follower 121 and the leader 111 is disconnected, the follower 121 suspends execution of an operation recorded in a log entry that carries a term ID of the leader 111.

The log entry carries the operation of the client 101 for data. In addition, in a period in which the node 111 serves as a leader, the log entry further carries the term ID of the leader 111.

When the communication connection between the follower 121 and the leader 111 is disconnected, for an unprocessed operation (the operation is carried in a log entry that includes the term ID of the leader 111), the follower 121 suspends processing of the operation. In a possible implementation of suspension, the follower 121 discards the operation. In a possible implementation of suspension, the follower 121 suspends execution of a process/thread of the operation, but does not discard the operation, for example, does not discard the log entry carrying the operation.

Step S33: The follower 121 becomes a candidate, and initiates election to another follower (including the follower 131) and the leader 111.

Specifically, when the communication connection between the follower 121 and the leader 111 is disconnected, the node 121 switches from a follower to a candidate.

The node 121 serves as a candidate and initiates election to the leader 111 and the another follower (including the follower 131). For example, the candidate 121 votes for the candidate 121, and sends a voting request to each of the leader 111 and the another follower. The voting request is used to request to vote for the candidate 121. Because the communication connection between the node 121 and the leader 111 is disconnected, the candidate 121 cannot receive a vote from the leader 111. Each (for example, the follower 131) of the other followers that is communicatively connected to the candidate 121 may vote for the candidate 121. Each vote for the candidate 121 represents an approval for the candidate 121 to become a new leader.

Step S34: The candidate 121 obtains votes from more than half of the nodes, and is elected as the new leader.

For example, in the scenario shown in FIG. 1 and FIG. 3, there are three nodes in total: the candidate 121, the old leader 111, and the follower 131. After the candidate 121 sends a voting request to each of the old leader 111 and the follower 131, the old leader 111 does not vote for the candidate 121, but the follower 131 votes for the candidate 121. The candidate 121 votes for the candidate 121. Therefore, the candidate 121 obtains two votes in total, and the candidate 121 becomes a new leader 121, that is, the node 121 changes from the candidate to the new leader.

A new term ID is set for the new leader 121, and the new term ID is greater than the term ID of the old leader 111. For example, a number obtained by adding 1 to the term ID of the old leader 111 is used as the new term ID of the new leader 121.

Step S35: The new leader 121 sends the new term ID of the new leader 121 to the client 101.

Correspondingly, the client 101 stores the new term ID of the new leader 121. Optionally, the client 101 updates the locally stored term ID of the old leader 111 to the new term ID of the new leader 121.

In a period in which the node 121 serves as the leader, for an operation of the client 101 for data, the client 101 records the new term ID of the new leader 121 in a log entry recording the operation, and sends the log entry carrying the new term ID of the new leader 121 to the node 111, the new leader 121, and another follower.

Step S36: The client 101 obtains a log entry that carries the old term ID of the old leader 111 and that is not completely executed.

In a period in which the node 111 serves as the leader, for an operation that is not determined by the client 101 as a successfully performed operation, the operation is an operation that is not completely executed. Correspondingly, a log entry carrying the operation is a log entry that is not completely executed. The log entry that is not completely executed carries the old term ID of the old leader 111. In step S36, the client 101 obtains the operation entry that is not completely executed.

Step S37: The client 101 updates the old term ID in the obtained log entry to the new term ID.

For the log entry obtained in step S36 (that is, a log entry that is determined by the client 101 as an incompletely executed log entry and that carries the old term ID of the old leader 111), in step S37, the old term ID in the log entry is changed to the new term ID of the new leader 121.

Step S38: The client 101 sends a log entry that carries the new term ID of the new leader 121 to each of the old leader 111, the new leader 121, and all followers.

For a log entry obtained by updating the term ID in step S37, the client 101 sends the log entry to the old leader 111, the new leader 121, and all the followers.

For a log entry (including a new operation of the client 101 for data and the new term ID of the new leader 121) newly generated by the client 101, the client 101 sends the log entry to the old leader 111, the new leader 121, and all the followers.

Optionally, in step S38, the client 101 preferentially sends the log entry obtained by updating the term ID in step S37, and then sends the log entry newly generated by the client 101.

Optionally, the old leader 111 receives the log entry that carries the new term ID of the new leader 121 and that is sent by the client 101. When the old leader 111 determines that the new term ID of the new leader 121 is greater than the old term ID of the old leader 111, the node 111 changes from the leader to a follower.

An objective of using the log entry to carry the term ID is to enable the leader and the follower to identify a log entry in a latest term, and to enable the leader and the follower to stop performing an operation recorded in a log entry in a historical term. For example, for the log entry that is sent by the client 101 to the old leader 111 and the follower 131 in step S38 and that is updated in step S37, when determining that the new term ID carried in the log entry is greater than the old term ID of the old leader 111, the old leader 111 stops executing the log entry that carries the old term ID, but executes the log entry that carries the new term ID. Similarly, when determining that the new term ID carried in the log entry is greater than the old term ID of the old leader 111, the follower 131 stops executing the log entry that carries the old term ID, but executes the log entry that carries the new term ID.

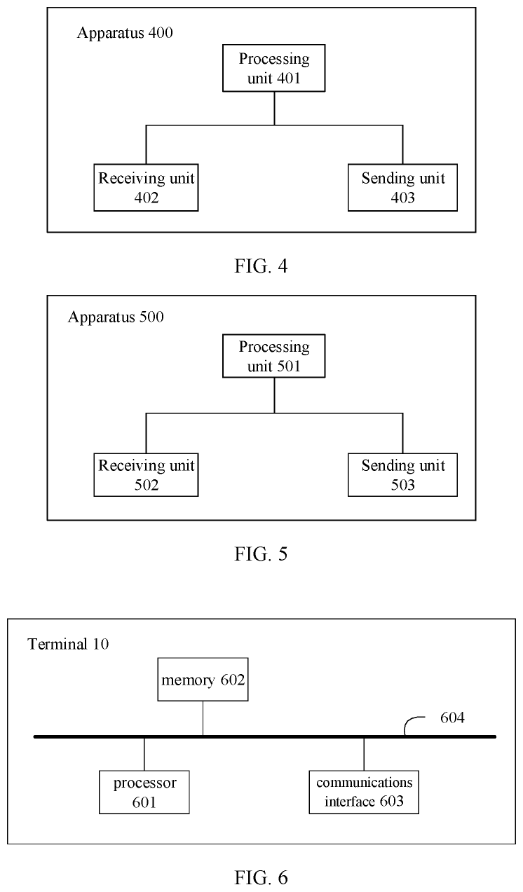

This application further provides an apparatus for implementing data consistency. The apparatus is deployed in the client 101 in the terminal 10 in this application. The apparatus includes functional units used by the client 101 in the terminal 10 to implement the foregoing method for implementing data consistency. In this application, how to divide the apparatus into the functional units is not limited. The following provides an example of division into the functional units, as shown in FIG. 4.

As shown in FIG. 4, the apparatus 400 for implementing data consistency includes:

a processing unit 401, configured to generate an operation for data, and record the operation as a log entry;

a sending unit 403, configured to send the log entry to a leader defined in the Raft protocol and a plurality of followers defined in the Raft protocol; and

a receiving unit 402, configured to receive a plurality of response messages in a preset time period, where the response messages indicate that the operation is successfully performed, different response messages are from different nodes, and all of the plurality of response messages are from the plurality of followers, or one of the plurality of response messages is from the leader and the other response messages are from the plurality of followers, where

the processing unit 401 is configured to: when a total quantity of the plurality of response messages received by the client in the preset time period is greater than half of a quantity of nodes, determine that the operation is successfully performed, where the quantity of nodes is a sum of a quantity of the leader and a quantity of the plurality of followers.

Optionally, the processing unit 401 is configured to add a term ID of the leader to the log entry before the client sends the log entry to the leader and the plurality of followers.

Optionally, the receiving unit 402 is configured to receive the term ID sent by the leader.

Optionally, the processing unit 401 is configured to: when the client receives a new term ID sent by a new leader and the new term ID is greater than the term ID of the leader, obtain a log entry that carries the term ID and that is not completely executed, where the new leader is one of the plurality of followers;

the processing unit 401 is configured to update the term ID in the obtained log entry to the new term ID; and

the sending unit 403 is configured to send a log entry that carries the new term ID to the leader, the new leader, and a follower other than the new leader in the plurality of followers.

This application provides an apparatus for implementing data consistency. The apparatus is deployed in a node of a server in this application. The apparatus includes functional units used by the node of the server to implement the foregoing method for implementing data consistency. In this application, how to divide the apparatus into the functional units is not limited. The following provides an example of division into the functional units, as shown in FIG. 5.

As shown in FIG. 5, the apparatus 500 for implementing data consistency includes:

a receiving unit 502, configured to receive a log entry sent by a client defined in the Raft protocol, where the log entry records an operation of the client for data; and

a processing unit 501, configured to: perform the operation recorded in the log entry, and after successfully performing the operation, send a response message indicating that the operation is successfully performed to the client.

Herein, the apparatus 500 may be deployed in a leader or a follower.

Optionally, the leader includes a sending unit 503, and the sending unit 503 is configured to send a term ID of the leader to the client.

Optionally, the processing unit 501 in the follower is configured to: periodically detect a communication connection between the follower and the leader, and when the communication connection between the follower and the leader is disconnected, suspend execution of an operation recorded in a log entry that carries the term ID of the leader.

Optionally, the processing unit 501 in the follower is configured to periodically detect the communication connection between the follower and the leader, where the follower becomes a candidate when the communication connection between the follower and the leader is disconnected;

the processing unit 501 in the candidate is configured to initiate election to another follower and the leader; and

when the candidate is elected as a new leader, the processing unit 501 in the new leader is configured to send a new term ID of the new leader to the client.

In this application, the terminal 10 may be a mobile terminal such as a thin client (TC), a smartphone, a tablet computer, a wearable device, or an in-vehicle computer. Optionally, the terminal 10 may be a server.

Optionally, FIG. 6 schematically provides a possible basic hardware architecture of the terminal 10.

Referring to FIG. 6, the terminal 10 includes a processor 601, a memory 602, a communications interface 603, and a bus 604.

In the terminal 10, there may be one or more processors 601. FIG. 1 shows only one of the processors 601. Optionally, the processor 601 may be a central processing unit (CPU). If the terminal 10 includes a plurality of processors 601, the plurality of processors 601 may be of a same type or different types. Optionally, the plurality of processors 601 in the terminal 10 may be integrated into a multi-core processor.

The memory 602 stores a computer instruction and data. The computer instruction and the data that are stored in the memory 602 are used to implement steps performed by the client 101, and/or are used to implement the apparatus 400. The memory 602 may be any one or any combination of the following storage media: a nonvolatile memory (such as a read-only memory (ROM), a solid-state drive (SSD), a hard disk drive (HDD), or an optical disc) and a volatile memory.

The communications interface 603 may be any one or any combination of the following components with a network access function: a network interface (such as an Ethernet interface) and a wireless network interface card.

The communications interface 603 is configured to perform data communication between the terminal 10 and another device (such as the server 12 and the server 13).

A thick line is used to represent the bus 604 in FIG. 1. The processor 601, the memory 602, and the communications interface 603 may be connected through the bus 604. In this way, the processor 601 may access the memory 602 by using the bus 604, and may further exchange data with another device (such as a terminal) by using the communications interface 603.

In this application, the terminal 10 executes the computer instruction in the memory 602, so that the client 101 of the terminal 10 performs the steps implemented by the client 101 in the method for implementing data consistency in this application, or the client 101 implements the apparatus 400.

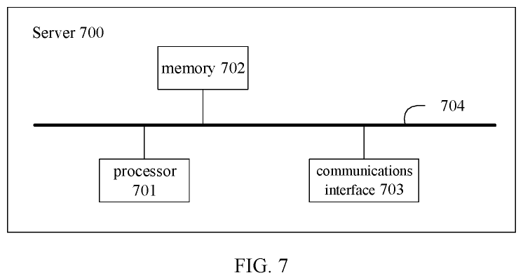

Optionally, FIG. 7 schematically provides a possible basic hardware architecture of the server in this application. For example, the server 700 shown in FIG. 7 may be configured to implement the server 12 and the server 13.

Referring to FIG. 1, the server 700 includes a processor 701, a memory 702, a communications interface 703, and a bus 704.

In the server 700, there may be one or more processors 701. FIG. 1 shows only one of the processors 701. Optionally, the processor 701 may be a central processing unit (central processing unit, CPU). If the server 700 includes a plurality of processors 701, the plurality of processors 701 may be of a same type or different types. Optionally, the plurality of processors 701 in the server 700 may be integrated into a multi-core processor.

The memory 702 stores a computer instruction and data. The computer instruction and the data stored in the memory 702 are used to implement steps implemented by a node (a leader, a follower, or a candidate), and/or are used to implement the apparatus 500. The memory 702 may be any one or any combination of the following storage media: a nonvolatile memory (such as a read-only memory (ROM), a solid-state drive (SSD), a hard disk drive (HDD), or an optical disc) and a volatile memory.

The communications interface 703 may be any one or any combination of the following components with a network access function: a network interface (such as an Ethernet interface) and a wireless network interface card.

The communications interface 703 is configured to perform data communication between the server 700 and another device (such as the terminal 10).

A thick line is used to represent the bus 704 in FIG. 1. The processor 701, the memory 702, and the communications interface 703 may be connected through the bus 704. In this way, the processor 701 may access the memory 702 by using the bus 704, and may further exchange data with another device (such as the terminal 10) by using the communications interface 703.

In this application, the server 700 executes the computer instruction in the memory 702, so that the server 700 performs steps implemented by the node (the leader, the follower, or the candidate) in the method for implementing data consistency in this application, or the node (the leader, the follower, or the candidate) implements the apparatus 500.

This application provides a computer-readable storage medium. The computer-readable storage medium stores a computer instruction. When the processor 601 in the terminal 10 executes the computer instruction, the terminal 10 implements the steps performed by the client 101 in the foregoing method for implementing data consistency.

This application provides a computer-readable storage medium. The computer-readable storage medium stores a computer instruction. When the processor 701 in the server 700 executes the computer instruction, the server 700 implements the steps performed by the node (such as the leader, the follower, or the candidate) in the foregoing method for implementing data consistency.

This application provides a computer program product. The computer program product includes a computer instruction, and the computer instruction is stored in the computer-readable storage medium. The processor 601 in the terminal 10 may read the computer instruction from the computer-readable storage medium, and the processor 601 executes the computer instruction, so that the terminal 10 implements the steps performed by the client 101 in the foregoing method for implementing data consistency.

This application provides a computer program product. The computer program product includes a computer instruction, and the computer instruction is stored in the computer-readable storage medium. The processor 701 in the server 700 may read the computer instruction from the computer-readable storage medium, and the processor 701 executes the computer instruction, so that the server 700 implements the steps performed by the node (such as the leader, the follower, or the candidate) in the foregoing method for implementing data consistency.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments, without departing from the protection scope of the claims.

What is claimed is:

1. A method for implementing data consistency, wherein the method comprises:
generating, by a client defined in the Raft protocol, an operation for data, and recording the operation as a log entry;
sending, by the client, the log entry to a plurality of nodes, wherein the plurality of nodes comprise a leader defined in the Raft protocol and a plurality of followers defined in the Raft protocol;
receiving, by the client, a plurality of response messages in a preset time period, wherein the response messages indicate that the operation is successfully performed, different response messages are from different nodes, and all of the plurality of response messages are from the plurality of followers, or one of the plurality of response messages is from the leader and the other response messages are from the plurality of followers; and
when a total quantity of the plurality of response messages received by the client in the preset time period is greater than half of a quantity of the plurality of nodes, determining that the operation is successfully performed.

2. The method according to claim 1, wherein the method comprises:
before the client sends the log entry to the plurality of nodes, adding, by the client, a term ID of the leader to the log entry.

3. The method according to claim 2, wherein the method comprises:
receiving, by the client, the term ID sent by the leader.

4. The method according to claim 2, wherein the method comprises:
when the client receives a new term ID sent by a new leader and the new term ID is greater than the term ID of the leader, obtaining, by the client, a log entry that carries the term ID and that is not completely executed, wherein the new leader is one of the plurality of followers;
updating, by the client, the term ID in the obtained log entry to the new term ID; and
sending, by the client, a log entry that carries the new term ID to the leader, the new leader, and a follower other than the new leader in the plurality of followers.

5. The method according to claim 1, wherein the method comprises:
receiving, by a follower of the plurality of followers, the log entry; and
performing, by the follower , the operation recorded in the log entry, and after successfully performing the operation, sending a response message indicating that the operation is successfully performed to the client.

6. The method according to claim 5, wherein the method comprises:
sending, by the leader, a term ID of the leader to the client.

7. The method according to claim 5, wherein the method further comprises:
periodically detecting, by the follower, a communication connection between the follower and the leader; and
when the communication connection between the follower and the leader is disconnected, suspending, by the follower, execution of an operation recorded in a log entry that carries the term ID of the leader.

8. The method according to claim 5, wherein the method further comprises:
periodically detecting, by the follower, a communication connection between the follower and the leader, wherein
the follower becomes a candidate when the communication connection between the follower and the leader is disconnected;
initiating, by the candidate, election to another follower and the leader; and
when the candidate is elected as a new leader, sending, by the new leader, a new term ID of the new leader to the client.

9. A terminal, comprising a processor and a memory, wherein the memory is configured to store a computer instruction, and the processor is configured to execute the computer instruction stored in the memory, so that the terminal deploys a client to implement the following functions:
generating an operation for data, and recording the operation as a log entry;
sending the log entry to a plurality of nodes, wherein the plurality of nodes comprise a leader defined in the Raft protocol and a plurality of followers defined in the Raft protocol; and
receiving a plurality of response messages in a preset time period, wherein the response messages indicate that the operation is successfully performed, different response messages are from different nodes, and all of the plurality of response messages are from the plurality of followers, or one of the plurality of response messages is from the leader and the other response messages are from the plurality of followers; and
determining that the operation is successfully performed when a total quantity of the plurality of response messages received by the client in the preset time period is greater than half of a quantity of the plurality of nodes.

10. The terminal according to claim 9, wherein the functions comprise:
adding a term ID of the leader to the log entry before the client sends the log entry to the plurality of nodes.

11. The terminal according to claim 10, wherein the functions comprise:
receiving the term ID sent by the leader.

12. The terminal according to claim 10, wherein the functions comprise:
obtaining a log entry that carries the term ID and that is not completely executed, when the client receives a new term ID sent by a new leader and the new term ID is greater than the term ID of the leader, wherein the new leader is one of the plurality of followers;
updating the term ID in the obtained log entry to the new term ID; and
sending a log entry that carries the new term ID to the leader, the new leader, and a follower other than the new leader in the plurality of followers.

13. A server, comprising a processor and a memory, wherein the memory is configured to store a computer instruction, and the processor is configured to execute the computer instruction stored in the memory, so that the server works as a node to realize functions, wherein the node is a leader defined in the Raft protocol or a follower defined in the Raft protocol, and wherein the functions comprise:
receiving a log entry sent by a client defined in the Raft protocol, wherein the log entry records an operation of the client for data; and
performing the operation recorded in the log entry, and after successfully performing the operation, sending a response message indicating that the operation is successfully performed to the client.

14. The server according to claim 13, wherein the functions comprise:
sending a term ID of the leader to the client.

15. The server according to claim 13, wherein the functions comprise:
periodically detecting a communication connection between the follower and the leader, and when the communication connection between the follower and the leader is disconnected, suspending execution of an operation recorded in a log entry that carries the term ID of the leader.

16. The server according to claim 13, wherein the functions comprise:
periodically detecting a communication connection between the follower and the leader, wherein the follower becomes a candidate when the communication connection between the follower and the leader is disconnected;
initiating election to another follower and the leader; and
when the candidate is elected as a new leader, sending a new term ID of the new leader to the client.
